(19) United States
(12) Patent Application Publication
(10) Pub. No.: US 2011/0137884 A1
(43) Pub. Date: Jun. 9, 2011

(54) TECHNIQUES FOR AUTOMATICALLY INTEGRATING SEARCH FEATURES WITHIN AN APPLICATION

(76) Inventors: SathyaKhala Anantharajan, Coimbatore (IN); Vijesh Kuppuraj, Coimbatore (IN); Scott Alan Isaacson, Woodland Hills, UT (US); Stanislav Visnovsky, Prerov nad Labem (CZ)

(21) Appl. No.: 12/634,038

(22) Filed: Dec. 9, 2009

(51) Int. Cl. G06F 17/30

(52) U.S. Cl. 707/708; 707/E17.143

(57) ABSTRACT

Techniques for automatically integrating search features within an application are provided. Text is collected and used as a background search while a user enters the text into an application for purposes of acquiring related results. The related results are obtained from previous information entered by the user or received by the user within the application. Moreover, the related results are dynamically presented in a portion of the application as the user continues to enter the text into another and different portion of the application.

### BACKGROUND

Increasingly, electronic communications are being used in place of traditional hand written communications. It is now an uncommon scenario for individuals to communicate via written communications; most individuals today communicate verbally using cellular phones or communicate via messages sent via electronic mail (email), instant messages (IM's), and/or text messages.

In fact, individuals now frequently pay their bills and communicate with businesses via electronic mechanisms. Hand written communications have decreased so much in recent years that many educators worry that children growing up today no longer know how to read or write in cursive.

One benefit, which is associated with all the increased electronic communications, is that previously communicated information is capable of being retained in storage, searched, recalled, and analyzed.

Users often find that communications that they have received or that they have provided are repetitive or have been modified in non substantial manners. Yet, most of the time a user is forced to halt activity within an application and forced to manually access a search feature of the application to search for previous communications of the user. This manual search is disruptive to the user and often causes the user to loose focus on the communication that the user is producing. In some instances, the user may even have to exit his/her work to conduct the search and then recall the work once the search results are obtained.

Thus, what are needed are improved integrated searching capabilities from within applications.

### SUMMARY

In various embodiments, techniques for automatically integrating search features within an application are presented. More specifically, and in an embodiment, a method for integrating search features within an application is provided. Specifically, text is dynamically collected as it is being entered into an application by a user of the application. Next, multiple searches and continually and concurrently conducted, without user direction, as background processes to the application with the text and other new text as the text and new text are being entered by the user into the application. The multiple searches performed against previous information entered by the user into the application and previous information received by the user in the application. Also, results from the searches are dynamically presented in a portion of the application for visual inspection by a user as the user continues to provide the text and the new text in a second portion of the application.

### BRIEF DESCRIPTION OF THE DRAWINGS

FIG. 1 is a diagram of a method for automatically integrating search features within an application, according to an example embodiment.

FIG. 2 is a diagram of another method for automatically integrating search features within an application, according to an example embodiment.

FIG. 3 is a diagram of an integrated search system, according to an example embodiment.

FIG. 4 is an example interaction occurring between two users using chat applications, according to an example embodiment.

FIG. 5 is an example embedded plugin to an application using the techniques presented in the FIGS. 1-3, according to an example embodiment.

FIG. 6 depicts example notifications within a chat client that can occur using the techniques presented in the FIGS. 1-3, according to an example embodiment.

### DETAILED DESCRIPTION

A “resource” includes a user, service, system, device, directory, data store, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc.

As used herein “information” refers to different types of data such as data acquired from emails, Simple Network Management Protocol (SNMP) data, system logs, operating system logs, Instant message histories, text message histories, histories on social networking websites, conventional repositories, such as databases, directories, web portals, data produced by software applications or services, Application Programming Interface (API) generated data, event streams, etc. The information is gathered and indexed for purposes subsequent search and retrieval.

Various embodiments of this invention can be implemented as extensions or enhancements to existing network architectures and as extensions or enhancements to existing messaging applications.

Also, the techniques presented herein are implemented in machines, such as processor or processor-enabled devices. These machines are configured to specifically perform the processing of the methods and systems presented herein. Moreover, the methods and systems are implemented and reside within computer-readable storage media and processed on the machines configured to perform the methods.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

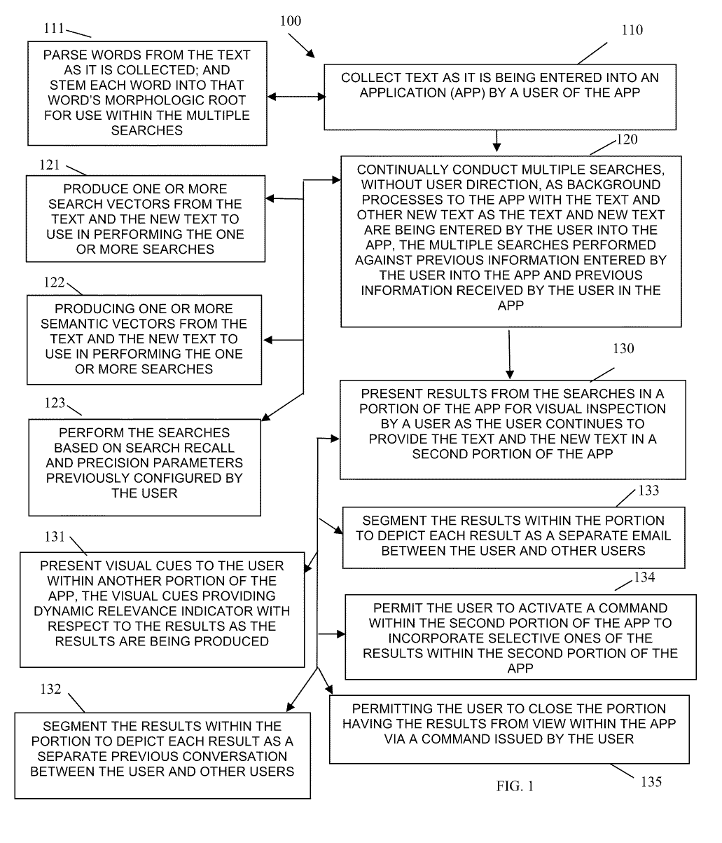

It is within this context that embodiments of the invention are now discussed within the context of FIGS. 1-3.

FIG. 1 is a diagram of a method 100 for automatically integrating search features within an application, according to an example embodiment. The method 100 (hereinafter “dynamic search service”) is implemented in a machine-accessible and computer-readable medium and instructions that execute on one or more processors (machines, computers, processors, etc.). The machine is specifically configured to process the dynamic search service. Furthermore, the dynamic search service is operational over and processes within a network. The network may be wired, wireless, or a combination of wired and wireless.

At 110, the dynamic search service collects text as it is being entered into an application by a user of the application. That is, the dynamic search service is a plug in that is integrated into the application. The application is a collaborative application, such as an email client or an instant messenger (IM) client. In another case, the application is a word processor application. The dynamic search service monitors text as it is entered by the user into the application.

According to an embodiment, at 111, the dynamic search service parses words from the text as it is being collected and stems each word into that word's morphological root. This is done to use the stemmed word as a search term for the searches that are being conducted and as described below with reference to the processing at 120. For example, words may be identified by separating characters, such as spaces, punctuation, etc. The words are then stemmed, so if a word “falling” was detected, the word “fall” is used not “falling” and all other forms of “fall,” such as “falls,” etc. Stemming can improve the search accuracy and improve search performance.

At 120, the dynamic search service continually and dynamically conducts multiple searches using the collected text that is being entered by the user into the application. These searches are done without user direction. That is, the user does not affirmatively select a command or an option to perform a search; rather, the application is preconfigured to have an “always searching” feature on so that the searches are done automatically and without any user direction or manipulation.

The searches are executed as background processes to the application. The user continues to interact with and use the application in the normal manner that the user would and while or during this interaction, the dynamic search service continually and dynamically performs multiple background searches.

The text entered into the application and any new text that is being entered into the application by the user is used as the search terms for performing the searches. Furthermore, the searches are performed against previous information entered by the user into the application and previous information received by the user within the application.

So, the search repository for which the searches are conducted against includes information related to previous conversations that the user had or emails that the user had. It is noted that in some cases the search repository (previous information) can be from a different application that is of the same type as the application the user is interacting with. In other words, the user may have multiple different IM clients and the previous information that is searched includes IM logs and files from each of those IM clients. The same type of application is used but the two applications are different from one another. Again, this can be first and second IM clients or first and second email clients.

According to an embodiment, at 121, the dynamic search service produces one or more search vectors from the text and the new text to use in performing the one or more searches. A search vector can include a variety of information in vector format and the vector used to perform the search. Some example information that can be included in the search vector can include word frequency, word weights, phrases, word proximity to other words, and the like.

In another case, at 122, the dynamic search service produces one or more semantic vectors from the text and the new text to use in performing the one or more searches. Here, the semantic vector can include categories for words or phrases within the vector. So, the term “baseball” can include a semantic representation within the vector for “sport,” such that any sport (baseball, football, basketball, soccer, etc.) can be designated as related if detected in the search repository (previous information). So, matches to specific words do not have to occur when the search is performed; rather, semantic searching can take place using semantic vectors.

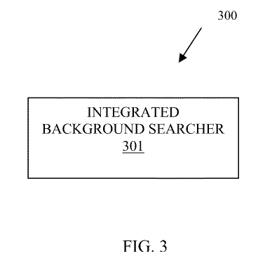

In still another situation, at 123, the dynamic search service performs the searches based on search recall and precision parameters that the user previously configured within the dynamic search service or the application. An example of search and recall and its interplay with one another is described below with the discussion of the FIG. 3.

At 130, the dynamic search service presents results from the searches in a portion of the application for visual inspection by a user. This presentation occurs in a dynamic manner and is continually changing as the results of the search change and as the user enters new text that alters the searching. The user continues to enter the text and new text in a second portion of the application. The portion where the results are presented can be a popup window or a segmented window integrated into the application.

According to an embodiment, at 131, the dynamic search service presents visual cues to the user within another portion of the application. These visual cues provide a dynamic relevance indicator with respect to the results as the results are being produced. So, if the dynamic search service detects that the text and new text when compared to results from the previous information is within a threshold value, a color bar such as green can be displayed but when the comparison is outside the threshold value the color bar is presented in red. The threshold value, the color (visual cue), and location of the visual cue within the application can all be configured by the user. A profile of the user can also be used to set the threshold value, the visual cue, and the location of the visual cue. The profile is acquired based on an identity of the user and applied automatically by the dynamic search service.

In a particular case, at 132, the dynamic search service segments the results within the portion of the application in order to depict each result as a separate previous conversation (IM thread) between the user and other users. Here, the application is an IM client.

In another case, at 133, the dynamic search service segments the results within the portion of the application to depict each result as a separate email between the user and other users. Here, the application is an email client.

In some situations, at 134, the dynamic search service permits the user to activate a command (or defined keystroke) within the second portion of the application (the portion that the user is entering the text and new text) to automatically incorporate selective ones of the results within the second portion of the application. For example, as results are being displayed in the portion of the application, a function key label can be displayed with each result, such that the user can hit the corresponding function key within the second portion of the application and essentially copy and paste from the first portion (desired results) into the second portion.

In another case, at 135, dynamic search service permits the user to activate a key or command within the second portion of the application to open and close the portion having the results. In this manner, a single key stroke can permit the portion with the results to be displayed or hidden from view.

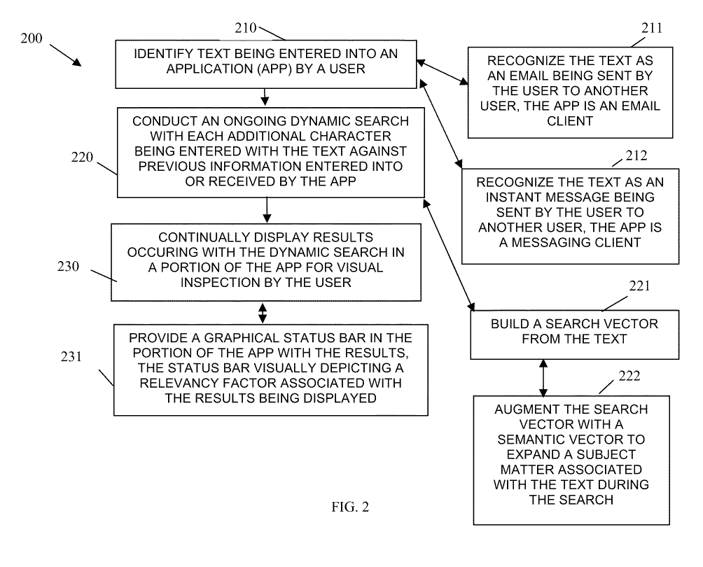

FIG. 2 is a diagram of another method 200 for automatically integrating search features within an application, according to an example embodiment. The method 200 (hereinafter “integrated search service”) is implemented in a machine-accessible and computer-readable storage medium as instructions that execute on one or more processors of a network node. The integrated search service is operational over a network. The network may be wired, wireless, or a combination of wired and wireless. Furthermore, the processor is specifically configured to process the integrated search service.

The integrated search service presents another and in some cases enhanced processing perspective of the dynamic search service represented by the method 100 of the FIG. 1.

At 210, the integrated search service identifies text being entered into an application by a user. Again, this occurs in a dynamic and real time fashion, such that as a character of text is displayed in the application after being entered by the user, the integrated search service identifies and copies that character.

According to an embodiment, at 211, the integrated search service recognizes the text as an email being composed and sent from the user to another user. Here, the application is an email client of the user.

In another case, at 212, the integrated search service recognizes the text as an instant message being sent by the user to another user. Here, the application is a messaging client of the user.

At 220, the integrated search service conducts an ongoing dynamic search with each additional character being entered with the text against previous information entered into or received by the application. So, the searching is done against a repository of data having previous transactions of the application or previous transactions of other different applications that are of the same type as the application. So, the search repository can include email files and logs from multiple different email clients; or the search repository can include IM files or logs from multiple different IM clients.

In an embodiment, at 221, the integrated search service builds a search vector from the text. Continuing with the embodiment of 221 and at 222, the integrated search service augments the search vector with a semantic vector to expand a subject matter associated with the text during the search. This was discussed above with reference to the method 100 of the FIG. 1.

At 230, the integrated search service continually and dynamically displays results occurring with the dynamic search in a portion of the application for visual inspection by the user.

Continuing with the embodiment of 230 and at 231, the integrated search service provides a graphical status bar in the portion of the application with the results. The status bar visually depicting a relevancy factor associated with the results being displayed.

FIG. 3 is a diagram of an integrated search system 300, according to an example embodiment, according to an example embodiment. The integrated search system 300 is implemented in a machine-accessible and computer-readable storage medium as instructions that execute on one or more processors (multiprocessor) and that is operational over a network. The one or more processors are specifically configured to process the components of the integrated search system 300. Moreover, the network may be wired, wireless, or a combination of wired and wireless. In an embodiment, the integrated search system 300 implements, among other things, certain aspects of the methods 100 and 200 represented by the FIGS. 1 and 2, respectively.

The integrated search system 300 includes an integrated background searcher 301.

The integrated background searcher 301 is implemented within and resides within a computer-readable storage medium and is to process on one or more processors of the network. Example aspects of the integrated background searcher 301 were presented in detail with reference to the methods 100 and 200 of the FIGS. 1 and 2, respectively.

The integrated background searcher 301 is configured to be integrated into an application to monitor text being entered by a user into an application. That is, the text is dynamically and in real-time captured by the integrated background searcher 301. The integrated background searcher 301 is also configured to conduct a dynamic and real-time search on the text captured against previous information entered by the user into or received by the user within the application.

The integrated background searcher 301 is further configured to dynamically and in real time present results from the background search within the application as the results are being detected in the previous information. So, as the user changes text in the application the search results are changing and are presented within a modified portion of the application.

In an embodiment, the previous information is data logged, filed, or archived by the user within the application from previous communications made with the application to one or more other users. So, the user has a repository of previous communications retained within the context of the application and that repository represents the previous information.

According to an embodiment, the application that the user is interfacing with is an email client or a messaging client.

In a particular case, the integrated background searcher 301 is initially configured by the user to set a search sensitivity value for the background search and to identify storage locations for obtaining the previous information.

In an embodiment, the search sensitivity can define recall and precision values for search results; for example, recall can be set by the user to be greater than 80% with precision being 60%. As recall goes up precision goes down and vice versa. Suppose a universe of documents having the word ball in them is 100 documents, but only 50 of those documents are actually about balls. In this example, 100% recall returns all 100 documents but since only 50 are about balls the precision is 50%. Suppose the precision was 100%, then recall would be 50% because all 50 documents about balls are returned but 50 documents are missed having the word ball referenced in them. The user can set precision and recall values for the search sensitivity; the greater the precision value the more likely some relevant documents are missed; and the greater the recall value the more likely the results have irrelevant material in them.

Search sensitivity can also include techniques that expand the scope of the search beyond words included in the text entered by the user. For example, suppose the search sensitivity includes semantic classifications, then categories identified by combinations of terms in the text can be mapped to other text similarly assigned to those categories. This can expand the scope of the search to semantic classifications identified in the text.

Some example situations and illustrations are now presented that utilize the techniques presented herein and above. Two different cases are presented. These cases are as follows.

CASE 1: A user is composing a message and is simply typing the contents of the message into the editor portion of an email or IM client and a search is constantly being performed in the background to look for data on the file system that might be relevant to the content of the message.

CASE 2: A user is holding a conversation with another user using one chat client, and that user is asked a question on a particular topic, which has already been discussed by that user in other threads in either the same or other chat clients. Using techniques presented herein, the user would not have to manually search the conversation logs of this chat client or the history logs of other chat clients. By presenting the relevant information to the user as and when the conversation is being held, the user gets to instant and dynamic access the information that the user desires and when the user needs it.

Each case is not discussed in greater detail.

### Case 1:

In this case, the end user is working inside of a messaging application like an email client or an IM client. The techniques presented herein automatically integrate a search using anything a user types at anytime to always be looking for similar content so that as the user is entering data the user might automatically find something similar that exists already to what the user is working on and the user can easily reuse that content in a new document being created by the user.

There is a background search engine that is integrated into any word processing, editing, productivity app (email, IM, word processor, spreadsheet, web page editor, command line shell, etc).

The background search engine has simple Application Programming Interfaces (APIs), such as and by way of example only:

StartInput( )
StopInput( )
SensitivityControl( )
Scope( )
ReadyCallback( )
ReferencesCallback( )

The application that accepts input (email or IM client) is written using the following pseudo-code:

```
============================
StartMessage( )
{
      searchBuffer = StartInput( );
      data = CollectMessageDataFromUser( );
      AddData (searchBuffer, data);
      AddData (messageBuffer, data);
}
RecivedSendCommand( )
{
      StopInput(searchBuffer);
      ... starts search
}
ReadyHandler( )
{
      /*Called by ReadyCallback*/
      ShowMatchGreen( );
}
ReferencesHandler( )
{
      /*Called by RefrencesCallback*/
      ShowReferences( );
}
```

The end use sees something like the following

+------------------------------------------+
| <blank email message> |
| |
| |
| |
| |
| |
| |
+------------------------------------------+

Then they start to type:

+------------------------------------------+
| I am sending you the FY2009 Budget for |
| OPS... |
| |
| |
| |
| |
| |
+------------------------------------------+

When they start they see a visual hint:

+------------------------------------------+
| I am sending you the FY2009 Budget for |
| OPS... |
| |
| +--------------------------------+ |
| | Found file | |
| | | |
| | ../odddir/oddname.ods | |
| | | |
| | that contains “FY2009 Budget | |
| | for OPS” , would you like to | |
| | _ attach, or | |
| | _ paste inline | |
| | | |
| | | |
| +--------------------------------+ |
| |
+------------------------------------------+

Or, in another scenario users type a really long email message and send it off and then two days later they get another ping about the same thing and they forget that they just typed this long answer into a previous sent email and so they start typing and most likely start typing the same answer. The auto search automatically finds the email and they can chose to custom cut and paste the email into the text or forward or add the email as an attachment.

This technique can also be used for any word processor or editing environment. In addition, the technique can be used to code segments for code development environments, research area, designs, etc.

Essentially, what is being dynamically typed into an application is used as constant, ongoing, input to a background search with a controlled scope for finding things similar or exactly the same as what the user is entering into the application.

### Case 2:

This embodiment can be implemented either as a Plug-in (where the application allows it) or as an independent program that presents the information that has been discussed herein.

This information could also be presented as a notification program.

### Example 1

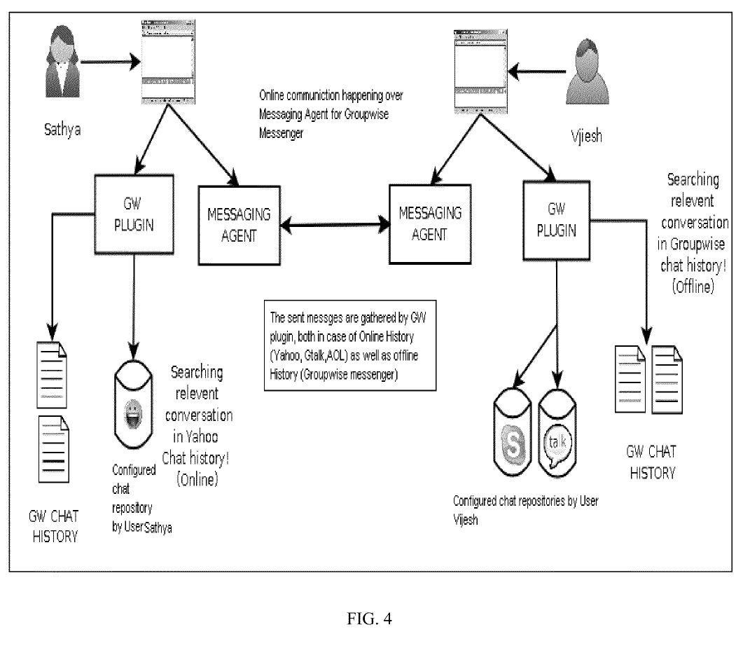

FIG. 4 is an example interaction occurring between two users using chat applications, according to an example embodiment

Specifically, FIG. 4 shows the communication between two users Sathya and Vijesh over GroupWise® Messenger.

The Messaging Agent is a messenger system component, which accesses Novell eDirectory® to authenticate the users; get their profiles and friends and transfers instant messages back and forth between its users. It is also responsible for passing the conversations to the archive agent if archive is enabled

Below is the work flow of the Plug-in in the GroupWise® Messenger (hereinafter “GW”):

1) UserA, installs the GW Chat Plug-in.

2) UserA configures the necessary chat application programs like Google Talk®, Skype®, and Yahoo Messenger® providing their user credentials in the GW Chat Plug-in. GW Chat Plug-in looks for relevant conversation history only from these configured messenger accounts. The GW Plug-in is designed to talk to various protocols that the chat applications support.

3) Search setting like “How old history could be searched?” can be configured in GW Chat Plug-in as well.

4) Consider a conversation between User Santa and User John in Yahoo messenger at around 10:30 a.m.:

Conversation 1:
Santa (April 11 10:30 AM): Hey Dude! How are you doing?
John (April 11 10:31 AM): Hey I'm doing good . . . . Do you have any plans for the day?
Santa (April 11 10:32 AM): nope.
John (April 11 10:35 AM): Perfect, then I have 4 tickets for the movie “The Dark knight”. You wanna join?
Santa (April 11 10:37 AM): yeah . . . . I'm free . . . . We can also call Sathya and Vijesh.
John (April 11 10:38 AM): yes, can you just check with them, we all can meet in the Theatre hall. I got to go for an urgent work now
John (April 11 10:40 AM): can u pick them up and come to the show at sharp 02:15 pm, Hall is Europa, Seat nos: S11-14, PVR Cinemas.
Santa (April 11 10:41 AM): ya shall do that . . . .
John (April 11 10:42 AM): See ya . . . meet u guys there.

At later point in time, consider the following chat conversation between User Santa and user Vijesh in GroupWise Messenger at around 11 a.m.:

Conversation 2:
Santa (April 11 11:01 AM): Hey Vijesh! Do you want to join us for a movie today?
Afternoon?
Vijesh (April 11 11.02 AM): ya . . . why not?
Vijesh (April 11 11:03 AM): BTW, who all are planning, and which movie?
Santa (April 11 11:04 AM): Myself, John, u and I'm planning to call Sathya too.

Note that while User Santa is chatting with User Vijesh, based on the context of the chat, the techniques presented herein show the history of the chat from Yahoo Messenger® between Santa and John that just happened.

The notification might show as follows:

Yahoo! Messenger >>>
John (April 11 10:35 AM): Perfect, then I have 4 tickets for the movie “The Dark knight”. You wanna join?
John (April 11 10:40 AM): can u pick them up and come to the show at sharp 02:15 pm,
   Hall is Europa, Seat nos: S11-14, PVR Cinemas.

Conversation 2 Continuation:
Santa (April 11 11:09 AM): The show is at PVR Theaters, Europa hall Seat no: S11-14 at 2:15 pm. Movie: The Dark Knight

6) Now based on the notification, Santa is able to see the past chat and give the relevant details to User Vijesh. This same thing happens if User Santa does a conversation with User Sathya too.

In the previous example one conversation was shown that had happened within a short time frame, but typically fractured conversations tend to cover a period of time and they could be held between the same or other different parties and it could be either one-on-one conversations or conference chats (many-to-many). In that case such notifications would render lot of meaningful results from which the conversation can be built usefully and avoids redundant time in searching through the histories of all chat channels.

The Chat Plug-in extracts the past histories from all the configured chat channels and builds a context by picking up the words such as ‘join’, ‘movie’, ‘theatre’, ‘plans’ etc. . . . and gives the most relevant details automatically in chronological order.

Where applicable, the APIs (if exposed) of the chat applications are used to retrieve the relevant conversation threads.

The notifications are shown either as a pop-up or can be embedded in the chat window for the respective user. Further the user can click on the notification to read the whole chat.

It is to be noted that if such a conversation is happening for the first time, the stated techniques try to render the data, but the results may be null. In that case no recommendations/notifications are shown.

### Example 2

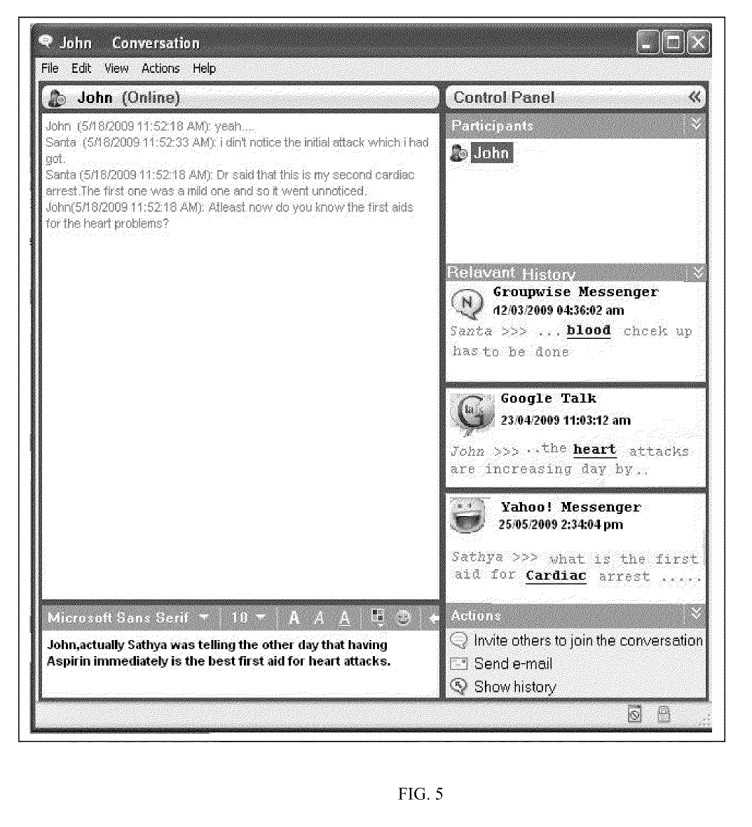

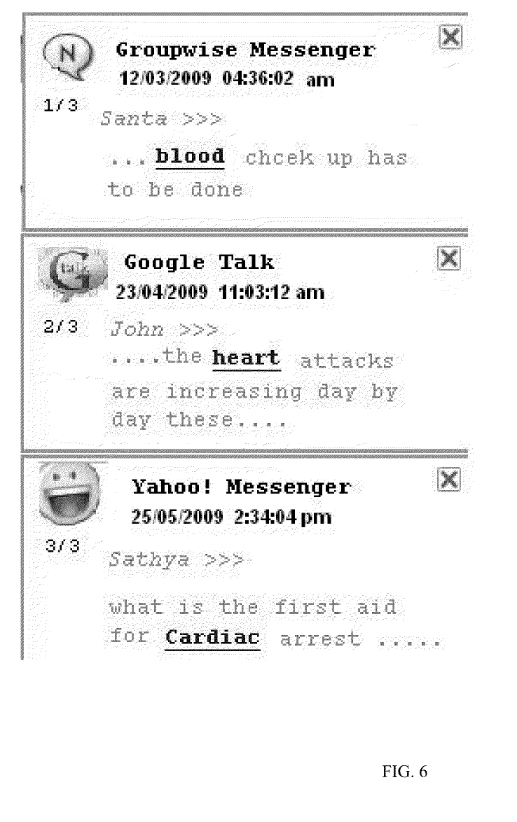

Below is the mock up of the notifications that are embedded into the GroupWise Messenger® client as a Plug-in FIG. 5 and as a separate utility that pops up as notifications in FIG. 6.

The conversations are built around the context “cardiac”, “attack”, “arrest”, “heart” etc.

By clicking the link shown in the histories, the entire chat can be viewed by the user.

The techniques presented herein are used for acquiring relevant content on the file system, across other applications and other chat channels automatically. These techniques ensure that the conventional manual search and integration of those search results into the original messaging content are eliminated and replaced with automated approaches.

The techniques can also be enhanced to include extraction of information that is posted on social networking or on professional networking sites.

For example, if user A had posted a Twitter message regarding say, American politics, and if a conversation between user A and user B is held on Obama's presidency/US politics, the twitter message would be presented as relevant information.

The approaches can also be extended to include any type of word processing environment. For example:

1. A user is writing a paragraph in a word processor (like OpenOffice.org Writer or MS Word)

2. There is a search that is going in the background and it finds relevant content.

3. The UI that finds the relevant content could be intrusive (pop up dialog box that interrupts the word processor) or passive (visual indicators that there is content that might be relevant).

4. The user decides to either reference or include the relevant content.

5. This approach also works well for boiler plate or common paragraphs that must be included in a document; sort of like work completion, this would be paragraph completion.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method implemented and residing within a computer-readable storage medium that is executed by one or more processors of a network, the one or more processors configured to perform the method, comprising:
collecting text as it is being entered into an application by a user of the application;
continually conducting multiple searches, without user direction, as background processes to the application with the text and other new text as the text and new text are being entered by the user into the application, the multiple searches performed against previous information entered by the user into the application and previous information received by the user in the application; and
presenting results from the searches in a portion of the application for visual inspection by a user as the user continues to provide the text and the new text in a second portion of the application.

2. The method of claim 1, wherein collecting further includes:
parsing words from the text as it is collected; and
stemming each word into that word's morphologic root for use within the multiple searches.

3. The method of claim 1, wherein continually conducting further includes producing one or more search vectors from the text and the new text to use in performing the one or more searches.

4. The method of claim 1, wherein continually conducting further includes producing one or more semantic vectors from the text and the new text to use in performing the one or more searches.

5. The method of claim 1, wherein continually conducting further includes performing the searches based on search recall and precision parameters previously configured by the user.

6. The method of claim 1, wherein presenting further includes presenting visual cues to the user within another portion of the application, the visual cues providing dynamic relevance indicator with respect to the results as the results are being produced.

7. The method of claim 1, wherein presenting further includes presenting further includes segmenting the results within the portion to depict each result as a separate previous conversation between the user and other users.

8. The method of claim 1, wherein presenting further includes presenting further includes segmenting the results within the portion to depict each result as a separate email between the user and other users.

9. The method of claim 1, wherein presenting further includes permitting the user to activate a command within the second portion of the application to incorporate selective ones of the results within the second portion of the application.

10. The method of claim 1, wherein presenting further includes permitting the user to close the portion having the results from view within the application via a command issued by the user.

11. A method implemented and residing within a computer-readable storage medium that is executed by one or more processors, the one or more processors configured to perform the method, comprising:
identifying text being entered into an application by a user;
conducting an ongoing dynamic search with each additional character being entered with the text against previous information entered into or received by the application; and
continually displaying results occurring with the dynamic search in a portion of the application for visual inspection by the user.

12. The method of claim 11, wherein identifying further includes recognizing the text as an email being sent by the user to another user, the application is an email client of the user.

13. The method of claim 11, wherein identifying further includes recognizing the text as an instant message being sent by the user to another user, the application is a messaging client of the user.

14. The method of claim 11, wherein conducting further includes building a search vector from the text.

15. The method of claim 14, wherein building further includes augmenting the search vector with a semantic vector to expand a subject matter associated with the text during the search.

16. The method of claim 11, wherein continually displaying further includes providing a graphical status bar in the portion of the application with the results, the status bar visually depicting a relevancy factor associated with the results being displayed.

17. A multiprocessor-implemented system, comprising:
an integrated background searcher implemented in a computer-readable storage medium and to execute on one or more processors of a network;
the integrated background searcher configured to integrate into an application to monitor text being entered by a user into the application, the text captured by the integrated background searcher and the integrated background searcher configured to conduct a dynamic background search on the text against previous information entered by the user into or received by the user within the application, the integrated background searcher further configured to dynamically present results from the background search within the application as the results are detected in the previous information.

18. The system of claim 17, wherein the application is an email client or a messaging client.

19. The system of claim 17, wherein the previous information is data logged, filed, or archived by the user within the application from previous user communications made with the application to one or more other users.

20. The system of claim 17, wherein integrated background searcher is initially configured by the user to set a search sensitivity value for the background search and to identify locations for obtaining the previous information.
